(19) United States
(12) Patent Application Publication
(10) Pub. No.: US 2023/0266560 A1
(43) Pub. Date: Aug. 24, 2023

(54) LENS UNIT

(71) Applicant: KYOCERA Corporation, Kyoto (JP)

(72) Inventor: Michiaki HIRAOKA, Yokohama-shi (JP)

(73) Assignee: KYOCERA Corporation, Kyoto (JP)

(21) Appl. No.: 18/165,005

(22) Filed: Feb. 6, 2023

(30) Foreign Application Priority Data
Feb. 24, 2022 (JP) 2022-26893

(51) Int. Cl. G02B 7/02

(52) U.S. Cl. CPC G02B 7/028; G02B 7/021; G02B 1/11

(57) ABSTRACT

A lens unit includes multiple lenses, a lens barrel, and a lens holder. The multiple lenses are aligned with respect to an optical axis. The lens barrel contains metal and includes an inside surface. The lens holder is on the inside surface and in contact with the multiple lenses. The lens holder contains resin.

### CROSS REFERENCES TO RELATED APPLICATION

The present invention contains subject matter related to Japanese Patent Application No. 2022-26893 filed in the Japan Patent Office on Feb. 24, 2022, the entire contents of which are incorporated herein by reference.

### BACKGROUND OF THE INVENTION

### 1. Field of the Invention

The present invention relates to a lens unit.

### 2. Description of the Related Art

Vehicle-mounted cameras are used in harsh environment in which, for example, temperature changes greatly. A highly reliable lens unit that can operate in a wide range of temperature is demanded for such a vehicle-mounted camera. For example, Japanese Unexamined Patent Application Publication No. 2019-20505 discloses a lens unit to be used in the vehicle-mounted camera. The lens unit has a structure in which lenses are press-fitted in resin-made lens frames and the lens frames are accommodated in a lens tube.

### SUMMARY OF THE INVENTION

According to an embodiment of the present disclosure, a lens unit includes multiple lenses, a lens barrel, and a lens holder. The multiple lenses are aligned with respect to an optical axis. The lens barrel contains metal and includes an inside surface. The lens holder is on the inside surface and in contact with the multiple lenses. The lens holder contains resin.

Accordingly, the lens unit of the present disclosure can maintain optical properties even if the ambient temperature around the vehicle-mounted camera changes repeatedly.

### BRIEF DESCRIPTION OF THE DRAWINGS

FIG. 1 is a cross-sectional view illustrating a lens unit according to a first embodiment;

FIG. 2 is a cross-sectional view illustrating a lens barrel and a lens holder according to the first embodiment;

FIG. 3A is an elevation view illustrating the lens barrel and the lens holder of the first embodiment as viewed from an object to be imaged;

FIG. 3B is an elevation view illustrating the lens barrel and the lens holder of the first embodiment as viewed from an image-forming surface;

FIG. 4 is a cross-sectional view illustrating a lens barrel and a lens holder according to a second embodiment; and

FIG. 5 is a cross-sectional view illustrating a lens unit according to a third embodiment.

### DESCRIPTION OF THE PREFERRED EMBODIMENTS

Embodiments of the present disclosure are described with reference to the drawings. Note that the present disclosure is not limited to the embodiments described below. Dimensional relationships in the drawings may deviate from what is described below to facilitate better understanding. The same elements in the drawings are denoted by the same reference signs.

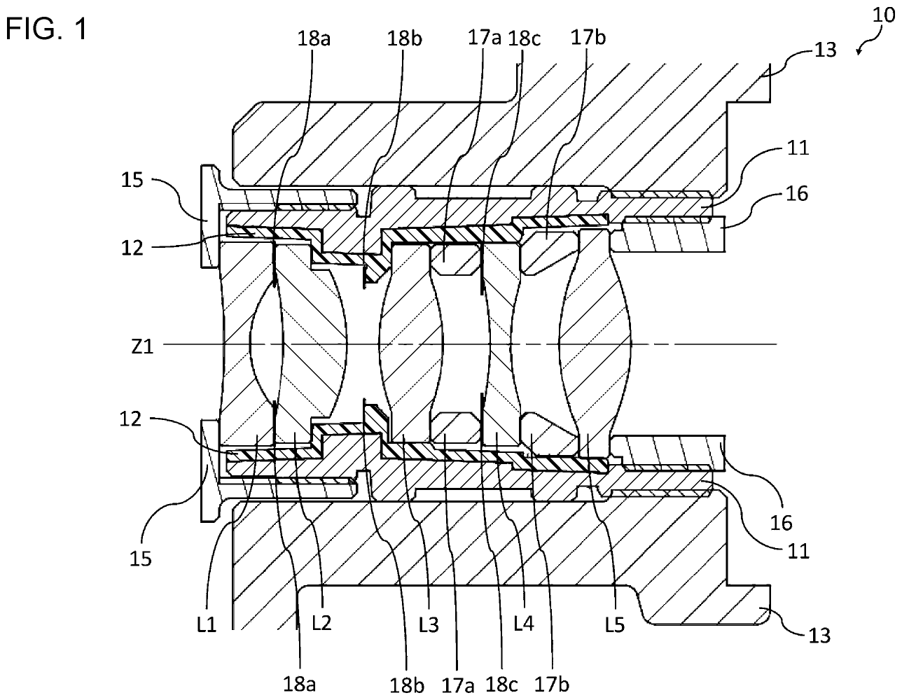

A lens unit according to a first embodiment of the present disclosure is described below with reference to FIG. 1. A lens unit 10 of the present embodiment includes a lens barrel 11, a lens holder 12, multiple lenses accommodated in the lens barrel 11, and a holder 13, as major components.

The lens barrel 11 accommodates at least one lens. The lens barrel 11 contains metal that can expand and contract less than a resin due to temperature change. Examples of the metal are aluminum and stainless steel. The lens barrel 11 may have a shape suitable to fit in the holder 13.

The lens barrel 11 may include a first portion, a second portion, and a third portion. The first portion includes a first end of the lens barrel 11 that faces an object to be imaged, and the second portion includes a second end of the lens barrel 11 that faces an image-forming surface. The first portion comprises a first inside diameter, and the second portion comprises a second inside diameter. The third portion is positioned between the first portion and the second portion, and comprises a third inside diameter. The third inside diameter may be smaller than the first inside diameter and the second inside diameter.

The lens holder 12 is in contact at least one lens. The lens holder 12 supports the side surface of the lens. The lens holder 12 contains a resin. Examples of the resin may be polyphenylene sulfide (PPS), polybutylene terephthalate (PBT), and polycarbonate (PC). The resin may contain glass fiber. The lens holder 12 may have a tubular shape that follows the inside surface of the lens barrel 11. The lens holder 12 is positioned on the inside surface of the lens barrel 11 and is formed integrally with the lens barrel 11 using insert molding. The lens holder 12 is formed integrally with the lens barrel 11 by inserting the lens barrel 11 in a die and injecting a resin into the die from the object side and from the image-forming-surface side of the lens barrel 11. The thickness of the lens holder 12 is not specifically limited insofar as the lens holder 12 can be produced by injection molding. The resin has a black color. The lens holder 12 containing the resin eliminates the necessity of antireflective coating using a black paint on the inside surface of the lens holder, which is normally necessary in the case of a metallic lens holder. The lens holder 12 containing the resin can decrease reflection of incident light.

In the present embodiment, the lenses accommodated in the lens barrel 11 include five lenses, in other words, a first lens L1, a second lens L2, and a third lens L3, a fourth lens L4, and a fifth lens L5, as named from the object side. The first to fifth lenses L1 to L5 are arranged along the optical axis Z1 of the lens unit 10. The first to fifth lenses L1 to L5 form an object image on the image-forming surface of an image sensor (not illustrated). The image sensor is connected to the image-forming-surface side of the lens unit 10. All or part of the first to fifth lenses L1 to L5 may be made of glass.

The lens unit 10 is not limited to the above-described five-lens system having the first lens L1, the second lens L2, the third lens L3, the fourth lens L4, and the fifth lens L5. The lens unit 10 may include an arbitrary number of lenses that are made of an arbitrary material.

The optical axis Z1 of the lens unit 10 substantially coincides with the central axis of the lens barrel 11 after the lens unit 10 is assembled.

The lens unit 10 further includes a first holder ring 15, a second holder ring 16, a spacer 17a, a spacer 17b, an aperture 18a, an aperture 18b, and an aperture 18c, in addition to the first to fifth lenses L1 to L5.

The first holder ring 15 may be made of a metal. The first holder ring 15 is an annularly shaped holding member that comes into contact with the front surface of the first lens L1 and presses the first lens L1 against the lens barrel 11. The front surface of the first lens L1 is the surface that faces the object. The first holder ring 15 presses the front surface of the first lens L1, thereby fixing the lenses L1 and L2 inside the lens barrel 11.

The second holder ring 16 may be made of a metal. The second holder ring 16 is an annularly shaped holding member that comes into contact with the rear surface of the fifth lens L5 and presses the fifth lens L5 against the lens barrel 11. The rear surface of the fifth lens L5 is the surface that faces the image-forming surface. The second holder ring 16 presses the rear surface of the fifth lens L5, thereby fixing the lenses L3 to L5 inside the lens barrel 11.

The spacer 17a is positioned inside the lens holder 12 between the third lens L3 and the fourth lens L4. The spacer 17a maintains the space between the third lens L3 and the fourth lens L4. The spacer 17a may be made of a metal or a resin.

The spacer 17b is positioned inside the lens holder 12 between the fourth lens L4 and the fifth lens L5. The spacer 17b maintains the space between the fourth lens L4 and the fifth lens L5. The spacer 17b may be made of a metal or a resin.

The aperture 18a is positioned inside the lens holder 12 between the first lens L1 and the second lens L2. The aperture 18a serves to eliminate or reduce unnecessary rays other than the effective flux of light that enters the lens barrel 11. The aperture 18a may be made of a metal or a resin.

The aperture 18b is positioned inside the lens holder 12 between the second lens L2 and the third lens L3. The aperture 18b serves to eliminate or reduce unnecessary rays other than the effective flux of light that enters the lens barrel 11. The aperture 18b may be made of a metal or a resin.

The aperture 18c is positioned inside the lens holder 12 between the spacer 17a and the fourth lens L4. The aperture 18c serves to eliminate or reduce unnecessary rays other than the effective flux of light that enters the lens barrel 11. The aperture 18c may be made of a metal or a resin.

The holder 13 may contain a metal. The holder 13 may have a shape suitable to fit and engage with the lens barrel 11.

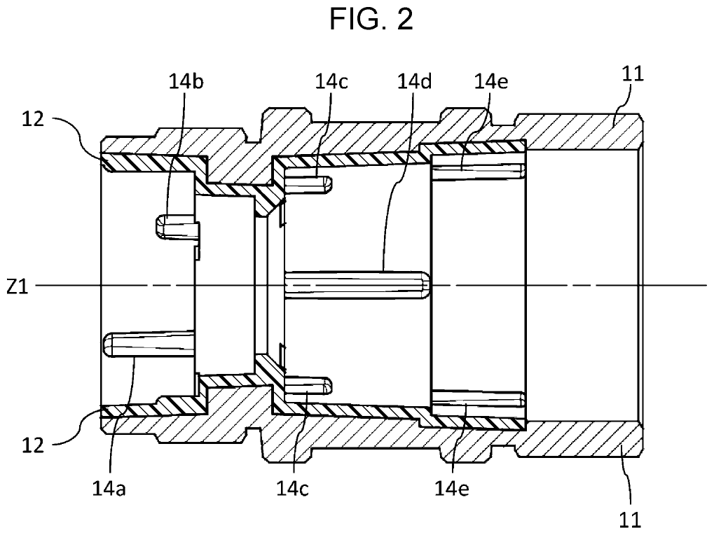

Next, the shapes of the lens barrel 11 and the lens holder 12 of the first embodiment are described with reference to FIG. 2. The lens holder 12 includes multiple protrusions 14 for holding the lenses formed on the inside surface of the lens holder 12. The protrusions 14 may be shaped so as to protrude from the inside surface of the lens barrel 11. The protrusions 14 may be shaped so as to extend along the optical axis Z1.

More specifically, the protrusions 14 include protrusions 14a for holding the first lens L1, protrusions 14b for holding the second lens L2, protrusions 14c for holding the third lens L3, protrusions 14d for holding the fourth lens L4, and protrusions 14e for holding the fifth lens L5, which are formed on the inside surface of the lens holder 12. The lens holder 12 may be formed integrally with the lens barrel 11 so as to cover the inside surface of the lens barrel 11. The protrusions 14a, the protrusions 14b, the protrusions 14c, the protrusions 14d, and the protrusions 14e may be formed integrally with the lens holder 12.

The protrusions 14a come into contact with the side surface of the first lens L1. The first lens L1 may be supported by at least three protrusions 14a. The protrusions 14a are arranged equidistantly in a circle on the inside surface of the lens holder 12 at the position at which the first lens L1 is disposed.

The diameter of an inscribed circle drawn so as to be in contact with the protrusions 14a may be smaller than the diameter of the first lens L1. The diameter of the inscribed circle of the protrusions 14a may be greater than the diameter of the second lens L2. The first lens L1 is press-fitted in the lens holder 12 at the position where the protrusions 14a are formed. Each protrusion 14a may be shaped such that the height of the protrusion 14a from the inside surface of the lens holder 12 gradually increases from the object-side end of the protrusion 14a toward the other end of the protrusion 14a near the image-forming surface. The object-side end of each protrusion 14a may be chamfered to facilitate smooth insertion of the first lens L1.

The protrusions 14b come into contact with the side surface of the second lens L2. The second lens L2 may be supported by at least three protrusions 14b. The protrusions 14b are arranged equidistantly in a circle on the inside surface of the lens holder 12 at the position at which the second lens L2 is disposed.

The diameter of an inscribed circle drawn so as to be in contact with the protrusions 14b may be smaller than the diameter of the second lens L2 to be held by the protrusions 14b. The second lens L2 is press-fitted in the lens holder 12 at the position where the protrusions 14b are formed. Each protrusion 14b may be shaped such that the height of the protrusion 14b from the inside surface of the lens holder 12 gradually increases from the object-side end of the protrusion 14b toward the other end of the protrusion 14b near the image-forming surface. The object-side end of each protrusion 14b may be chamfered to facilitate smooth insertion of the second lens L2.

The protrusions 14c come into contact with the side surface of the third lens L3. The third lens L3 may be supported by at least three protrusions 14c. The protrusions 14c are arranged equidistantly in a circle on the inside surface of the lens holder 12 at the position at which the third lens L3 is disposed.

The diameter of an inscribed circle drawn so as to be in contact with the protrusions 14c may be smaller than the diameter of the third lens L3 to be held by the protrusions 14c. The third lens L3 is press-fitted in the lens holder 12 at the position where the protrusions 14c are formed. Each protrusion 14c may be shaped such that the height of the protrusion 14c from the inside surface of the lens holder 12 gradually increases from the end of the protrusion 14c near the image-forming surface toward the object-side end of the protrusion 14c. The end of each protrusion 14c near the image-forming surface may be chamfered to facilitate smooth insertion of the third lens L3.

The protrusions 14d come into contact with the side surface of the fourth lens L4. The fourth lens L4 may be supported by at least three protrusions 14d. The protrusions 14d are arranged equidistantly in a circle on the inside surface of the lens holder 12 at the position at which the fourth lens L4 is disposed.

The diameter of an inscribed circle drawn so as to be in contact with the protrusions 14d may be smaller than the diameter of the fourth lens L4 to be held by the protrusions 14d. The diameter of the inscribed circle of the protrusions 14d may be greater than the diameter of the third lens L3. The fourth lens L4 is press-fitted in the lens holder 12 at the position where the protrusions 14d are formed. Each protrusion 14d may be shaped such that the height of the protrusion 14d from the inside surface of the lens holder 12 gradually increases from the end of the protrusion 14d near the image-forming surface toward the object-side end of the protrusion 14d. The end of each protrusion 14d near the image-forming surface may be chamfered to facilitate smooth insertion of the fourth lens L4.

The protrusions 14e come into contact with the side surface of the fifth lens L5. The fifth lens L5 may be supported by at least three protrusions 14e. The protrusions 14e are arranged equidistantly in a circle on the inside surface of the lens holder 12 at the position at which the fifth lens L5 is disposed.

The diameter of an inscribed circle drawn so as to be in contact with the protrusions 14e may be smaller than the diameter of the fifth lens L5 to be held by the protrusions 14e. The diameter of the inscribed circle of the protrusions 14e may be greater than the diameter of the fourth lens L4. The fifth lens L5 is press-fitted in the lens holder 12 at the position where the protrusions 14e are formed. Each protrusion 14e may be shaped such that the height of the protrusion 14e from the inside surface of the lens holder 12 gradually increases from the end of the protrusion 14e near the image-forming surface toward the object-side end of the protrusion 14e. The end of each protrusion 14e near the image-forming surface may be chamfered to facilitate smooth insertion of the fifth lens L5.

The first to fifth lenses L1 to L5 are press-fitted in the lens holder 12 at respective positions where the protrusions 14 are formed, which prevents the first to fifth lenses L1 to L5 from being displaced in a direction orthogonal to the optical axis Z1. The first to fifth lenses L1 to L5 are held by the lens holder 12 containing resin that is integrally formed with the lens barrel 11 containing metal. This eliminates clearance between the lens barrel 11 and the lenses L1 to L5. Accordingly, the lenses are not displaced easily even if the ambient temperature around the vehicle-mounted camera changes repeatedly. Thus, the optical axis Z1 of the first to fifth lenses L1 to L5 can be maintained such that the optical axis Z1 substantially coincides with the central axis of the lens barrel 11.

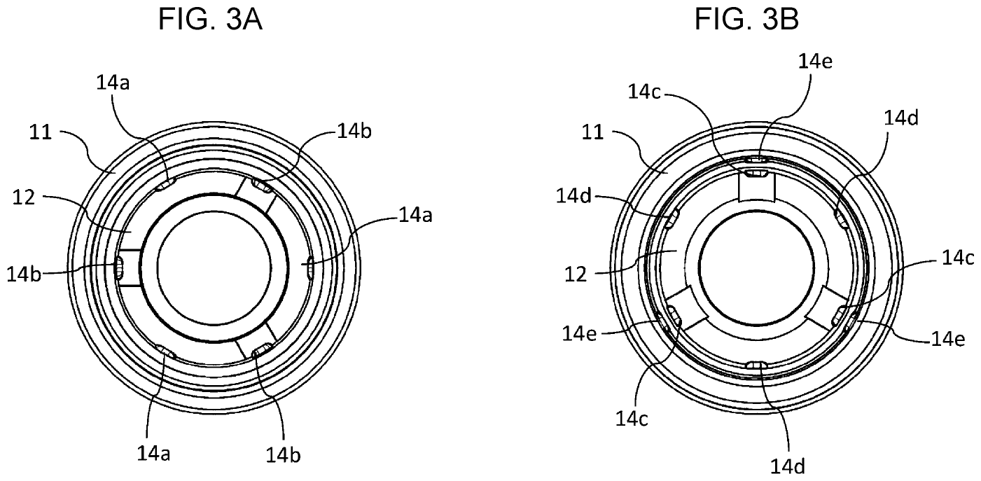

The shapes of the lens barrel 11 and the lens holder 12 of the first embodiment are described further with reference to FIGS. 3A and 3B. FIG. 3A is an elevation view illustrating the lens barrel 11 and the lens holder 12 as viewed from the object to be imaged. FIG. 3B is another elevation view illustrating the lens barrel 11 and the lens holder 12 as viewed from the image-forming surface.

The shapes of the lens barrel 11 and the lens holder 12 are described with reference to FIG. 3A. The height of the protrusions 14a and the height of the protrusions 14b can be determined such that the diameter of the inscribed circle of the protrusions 14a is greater than the diameter of the inscribed circle of the protrusions 14b. In the first embodiment, as the lens barrel 11 is viewed from the object, the protrusions 14a are disposed equidistantly and the protrusions 14b are also disposed equidistantly. However, the arrangements of the protrusions 14a and 14b are not limited to this.

The shapes of the lens barrel 11 and the lens holder 12 are described with reference to FIG. 3B. The height of the protrusions 14c and the height of the protrusions 14d may be set such that the diameter of the inscribed circle of the protrusions 14c is smaller than the diameter of the inscribed circle of the protrusions 14d. The height of the protrusions 14d and the height of the protrusions 14e may be set such that the diameter of the inscribed circle of the protrusions 14d is smaller than the diameter of the inscribed circle of the protrusions 14e. In the first embodiment, as the lens barrel 11 is viewed from the image-forming surface, the protrusions 14c and the protrusions 14d are arranged equidistantly, the protrusions 14d and the protrusions 14e are arranged equidistantly, and the protrusions 14c and the protrusions 14e are arranged equidistantly. However, the arrangements of the protrusions 14c, 14d, and 14e are not limited to this.

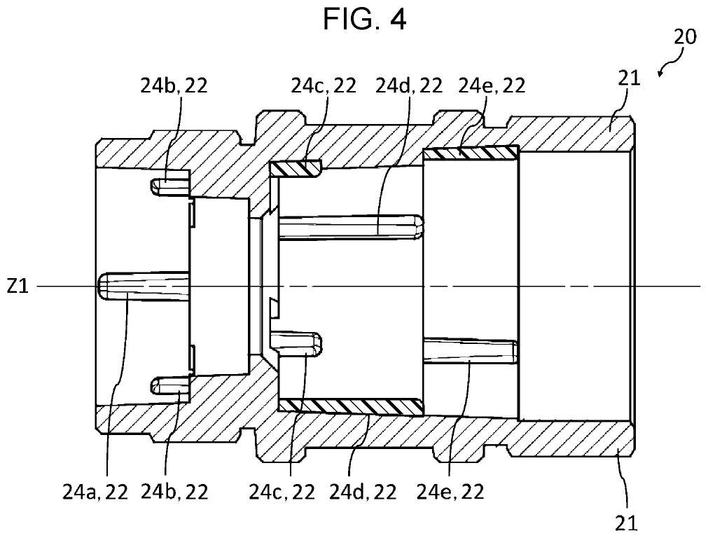

Next, the shapes of a lens barrel 21 and a lens holder 22 of a second embodiment of the present invention are described with reference to FIG. 4.

A lens unit 20 of the present embodiment includes a lens barrel 21, a lens holder 22, the first to fifth lenses L1 to L5 accommodated in the lens barrel 21, and a holder 23, as major components. The lens holder 22 of the lens unit 20 is different in shape from the lens holder of the lens unit 10 of the first embodiment.

The structure of the lens barrel 21 of the second embodiment is substantially the same as the lens barrel 11 of the first embodiment, and accordingly the description of the lens barrel 21 is omitted.

The same elements as those described in the first embodiment are denoted by the same reference signs. Unless stated otherwise, such elements have the same structures and functions, and accordingly duplicated descriptions are omitted.

The lens holder 22 includes multiple protrusions 24 for holding the lenses. More specifically, the protrusions 24 of the lens holder 22 include protrusions 24a for holding the first lens L1, protrusions 24b for holding the second lens L2, protrusions 24c for holding the third lens L3, protrusions 24d for holding the fourth lens L4, and protrusions 24e for holding the fifth lens L5.

The lens holder 22 may consist solely of the protrusions 24 that hold the first to fifth lenses L1 to L5. The thickness of the lens holder 22 is not specifically limited insofar as the lens holder 22 can be produced using resin-injection molding. The lens holder 22 may be formed by inserting the lens barrel 21 in a die and injecting a resin into the die from the object side and from the image-forming-surface side of the lens barrel 21. Alternatively, the lens holder 22 may be formed by forming resin-injection holes through the lens barrel 21 at positions at which respective protrusions 24 are formed and subsequently injecting resin through the holes. The lens holder 22 is formed so as to have a tubular shape that follows the inside surface of the lens barrel 21. Portions of the resin other than the protrusions 24 may be removed in a subsequent process. The resin expands or contracts more than the metal due to temperature change. In the present embodiment, the resin only remains as the protrusions 24. Accordingly, the lenses are not displaced easily even if the ambient temperature around the vehicle-mounted camera changes repeatedly.

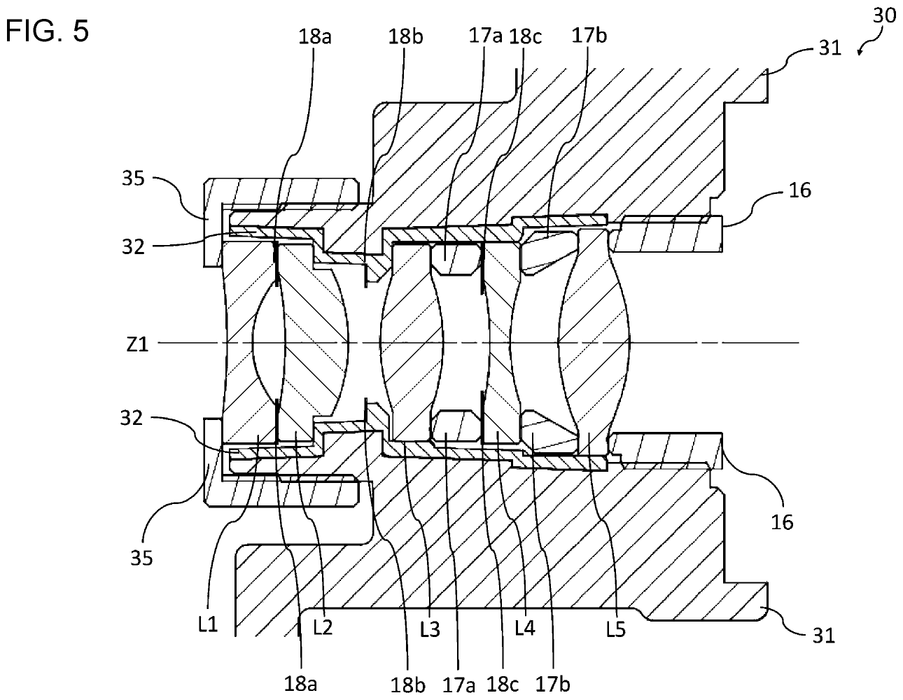

Next, a lens unit according to a third embodiment of the present invention is described with reference to FIG. 5.

A lens unit 30 of the present embodiment includes a lens barrel 31, a lens holder 32, the first to fifth lenses L1 to L5 accommodated in the lens holder 32, as major components. The lens unit 30 is different from the lens unit 10 of the first embodiment in that the lens unit 30 includes the lens barrel 31. The lens barrel 31 integrates the lens barrel 11 with the holder 13 of the first embodiment.

In the third embodiment, the structure of the lens holder 32 is substantially the same as that of the lens holder 12 of the first embodiment, and accordingly the description of the lens holder 32 is omitted.

The lens unit 30 further includes a first holder ring 35, the second holder ring 16, the spacer 17a, the spacer 17b, the aperture 18a, the aperture 18b, and the aperture 18c, in addition to the first to fifth lenses L1 to L5.

The same elements as those described in the first embodiment are denoted by the same reference signs. Unless stated otherwise, such elements have the same structures and functions, and accordingly duplicated descriptions are omitted. The first holder ring 35 presses the front surface of the first lens L1, thereby fixing the first and second lenses L1 and L2 inside the lens barrel 31.

The lens barrel 31 has the structure in which the lens barrel 11 and the holder 13 of the first embodiment are integrated with each other, which can decrease the number of components.

Some embodiments of the present disclosure have been described with reference to the drawings and through examples. Note that those skilled in the art can modify and alter the embodiments easily on the basis of the present disclosure. Accordingly, such modifications and alterations are deemed within the scope of the present disclosure. For example, the function of each component can be modified without causing logical inconsistency. Moreover, a single component can be divided or multiple components can be combined. Such modifications are also deemed within the scope of the present disclosure.

The lens unit of the present disclosure has been described as the lens unit for the vehicle-mounted camera. The lens unit may be used, for example, in a surveillance camera.

What is claimed is:

1. A lens unit comprising:
multiple lenses aligned with respect to an optical axis;
a lens barrel containing metal, and comprising an inside surface; and
a lens holder on the inside surface, in contact with the multiple lenses, and containing resin.

2. The lens unit according to claim 1, wherein
the lens holder comprises
an inner surface;
an outer surface closer to the lens barrel than the inner surface; and
at least one protrusion:
located on the inner surface; and
being in contact with the multiple lenses;
some of the at least one protrusion arranged equidistantly in a circle.

3. The lens unit according to claim 1, wherein
the lens barrel comprises
a first end;
a second end opposite to the first end;
a first portion including the first end, and comprising a first inside diameter;
a second portion including the second end, and comprising a second inside diameter; and
a third portion located between the first portion and second portion, and comprising a third inside diameter that is smaller than the first inside diameter and the second inside diameter.

4. The lens unit according to claim 1, wherein
the resin has a black color.
